(19) United States
(12) Patent Application Publication
(10) Pub. No.: US 2018/0006869 A1
(43) Pub. Date: Jan. 4, 2018

(54) CONTROL METHOD AND SYSTEM, AND ELECTRONIC APPARATUS THEREOF

(71) Applicant: Lenovo (Beijing) Co., Ltd., Beijing (CN)

(72) Inventors: Yuanyi ZHANG, Beijing (CN); Chuanyu ZHANG, Beijing (CN)

(21) Appl. No.: 15/626,429

(22) Filed: Jun. 19, 2017

(30) Foreign Application Priority Data
Jun. 30, 2016 (CN) 201610509525.7

(51) Int. Cl. H04L 29/08; H04W 84/20

(52) U.S. Cl. CPC H04L 29/08; H04W 84/20

(57) ABSTRACT

A control method is provided for a master terminal or a server. The control method includes obtaining input information; based on the input information, determining a response instruction and a response terminal of the input information; and executing the response instruction to control the response terminal to respond to the input information.

### CROSS-REFERENCES TO RELATED APPLICATIONS

This application claims priority of Chinese Patent Application No. 201610509525.7, filed on Jun. 30, 2016, the entire contents of which are hereby incorporated by reference.

### FIELD OF THE INVENTION

The present disclosure generally relates to the field of communication technology and, more particularly, relates to a control method and an electronic apparatus thereof.

### BACKGROUND

As the human-computer interaction technology becomes increasingly mature, it has been widely used in a variety of electronic equipment used by users in their daily life and work. Especially with the emergence of the Internet of Things (IOT), information physics systems, and other technologies, the importance of human-computer interaction technology cannot be under-emphasized.

However, in practical applications, especially when a current application scene includes a plurality of terminals all capable of human-computer interaction, it is difficult for the system to accurately determine which terminal from the plurality of terminals a user wishes to respond to, causing inconvenience to the user's work and daily life.

The disclosed control methods and systems are directed to solve one or more problems set forth above and other problems.

### BRIEF SUMMARY OF THE DISCLOSURE

A first aspect of the present disclosure is a control method for a master terminal. The control method includes obtaining input information; based on the input information, determining a response instruction and a response terminal of the input information; and executing the response instruction to control the response terminal to respond to the input information.

A second aspect of the present disclosure is an electronic apparatus. The electronic apparatus includes an electronic input device and a controller coupled to the electronic input device. The electronic input device obtains input information; and the controller determines, based on the input information, a response instruction and a response terminal of the input information, and executes the response instruction to control the response terminal to respond to the input information.

Other aspects of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 illustrates a flow chart of a control method consistent with the disclosed embodiments;

FIG. 2 illustrates a flow chart of another control method consistent with disclosed embodiments;

FIG. 3 illustrates a flow chart of another control method consistent with disclosed embodiments;

FIG. 4 illustrates a flow chart of another control method consistent with disclosed embodiments;

FIG. 5 illustrates a flow chart of another control method consistent with disclosed embodiments;

FIG. 6 illustrates a flow chart of another control method consistent with disclosed embodiments;

FIG. 7 illustrates a structural diagram of a controller consistent with disclosed embodiments;

FIG. 8 illustrates a structural diagram of an electronic apparatus consistent with disclosed embodiments; and

FIG. 9 illustrates a structural diagram of a control system applying a control method consistent with disclosed embodiments.

### DETAILED DESCRIPTION

Reference will now be made in detail to exemplary embodiments of the invention, which are illustrated in the accompanying drawings. Wherever possible, the same reference numbers will be used throughout the drawings to refer to the same or like parts. The described embodiments are some but not all of the embodiments of the present invention. Based on the disclosed embodiments and without inventive efforts, persons of ordinary skill in the art may derive other embodiments consistent with the present disclosure, all of which are within the scope of the present invention.

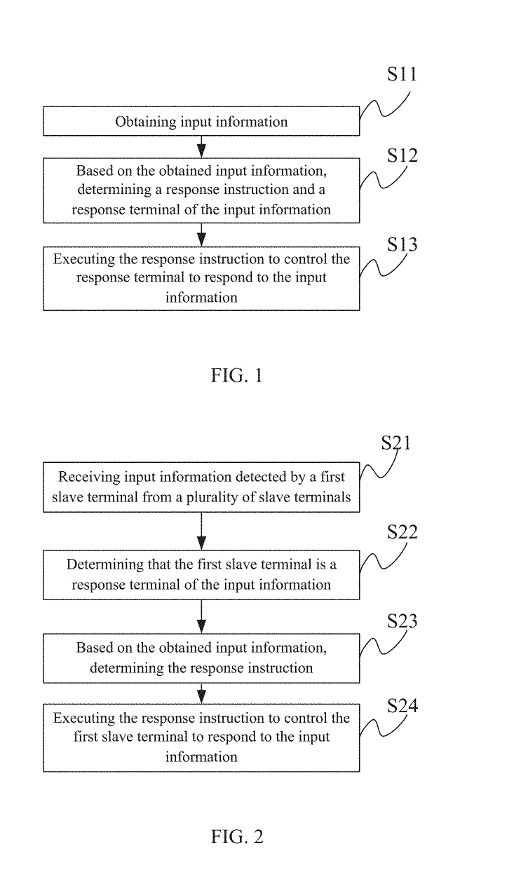

FIG. 1 illustrates a flow chart of a control method consistent with disclosed embodiments. The control method may be applied to a master terminal, which may be a control center in an application scene or application environment of the control method. The structure of the master terminal may be described in later parts of this disclosure. As shown in FIG. 1, the control method may include the following steps.

Step S11: Obtaining input information.

More specifically, the input information may be obtained based on a sound signal outputted from a sound utterance object, and generally may include a user's current demand. In practical applications, if the sound signal is within the detection range of the voice receiver of the master terminal, the input information can be obtained by the voice receiver of the master terminal. If the sound signal outputted by the sound utterance object is not within the detection range of the voice receiver of the master terminal, or the master terminal does not have the voice detection function, etc., the input information can be detected or collected by a slave terminal and then sent to the master terminal. Other ways of obtaining the input information may also be used.

A slave terminal may be a terminal having a voice detection function and a data transmission function, and slave terminals may be distributed in multiple spatial areas of an application scene, such that the sound signal outputted by the sound utterance object anywhere in the application scene can be obtained by at least one slave terminal or by the master terminal itself to obtain the input information. A master terminal may have a larger data processing capability than a slave terminal.

It should be noted that, depending on the actual needs, the slave terminal and/or the master terminal may have other functions, and any appropriate user terminal may be used as the master terminal or the slave terminal.

Step S12: Based on the obtained input information, determining a response instruction and a response terminal of the input information.

After obtaining the input information, the master terminal may analyze the input information with its substantial processing capability to determine a corresponding control instruction and a response terminal of the input information. Of course, the master terminal may transmit the input information to a server, and the server may analyze the input information and send an analysis result of the obtained input information back to the master terminal. The master terminal can then determine the response instruction corresponding to the input information and the response terminal of the input information.

When the input information is directly obtained by acquiring the sound signal by the slave terminal, the slave terminal may directly transmit the obtained input information to the server, and the server may then send the analysis result of the obtained input information back to the master terminal, such that the master terminal can determine the response instruction corresponding to the input information and the response terminal of the input information.

Thus, the analysis process of the input information may be performed by the master terminal or by the server. Further, the determined response terminal of the input information may be the master terminal itself, a first slave terminal from a plurality of slave terminals, or an output terminal, without any specific limitation on the response terminal, and different response terminals may correspond to different application scenes.

Step S13: Executing the response instruction to control the response terminal to respond to the input information.

After the master terminal determines the corresponding response instruction of the input information, and based on the different types of the response terminals, the response instruction may be executed in different ways.

Accordingly, after obtaining the input information, the master terminal may, based on the analysis result of the input information, accurately determine the corresponding response instruction and the response terminal. By executing the response instruction, the response terminal can be controlled to respond to the input information. Thus, based on the sound signal inputted by the user, the present disclosure can accurately determine the user's intention and meet the user's current needs, improving the control accuracy.

FIG. 2 illustrates a flow chart of another control method consistent with disclosed embodiments. Similarly, the control method shown in FIG. 2 may also be applied to a master terminal. As shown in FIG. 2, the control method may include the following steps.

Step S21: Receiving input information detected by a first slave terminal from a plurality of slave terminals.

According to the present disclosure, the application scene may be deployed with a master terminal and a plurality of slave terminals. The master terminal may be connected to the plurality of slave terminals by communication links, so as to realize data exchange between the master terminal and the slave terminals.

In practical applications, when a sound utterance object (e.g., a user) outputs a sound signal, it can be detected or collected by a slave terminal in the application scene, and the corresponding input information can be obtained. The slave terminal in this case may be a most desired slave terminal to detect the sound signal, i.e., a first slave terminal, and other slave terminals may not provide the input information. That is, only the first slave terminal detects the sound signal to obtain the input information.

Under such circumstance, the first slave terminal may be the slave terminal that is closest to the sound utterance object. If there is a correspondence relationship established in advance between the slave terminals and the spatial regions, the first slave terminal may be the slave terminal in a space region where the sound utterance object is located. Other ways to determine the first slave terminal may also be used.

Optionally, the plurality of slave terminals in the current application scene may all perform the signal acquisition to obtain the input information and the master terminal or server then analyzes the input information received from the plurality of slave terminals. The master terminal or server may determine the input information that meets a preset condition as the selected input information, and the slave terminal corresponding to the selected input information as the first slave terminal. That is, the first slave terminal may be a slave terminal selected from the plurality slave terminals and, afterwards, the input information transmitted by the first slave terminal can be further processed.

In addition, after the sound signal is generated by the sound utterance object, multiple slave terminals that detected the sound signal may each obtain the input information and transmit the input information to the server or the master terminal. The server or mater terminal may then determine the first slave terminal and the corresponding input information.

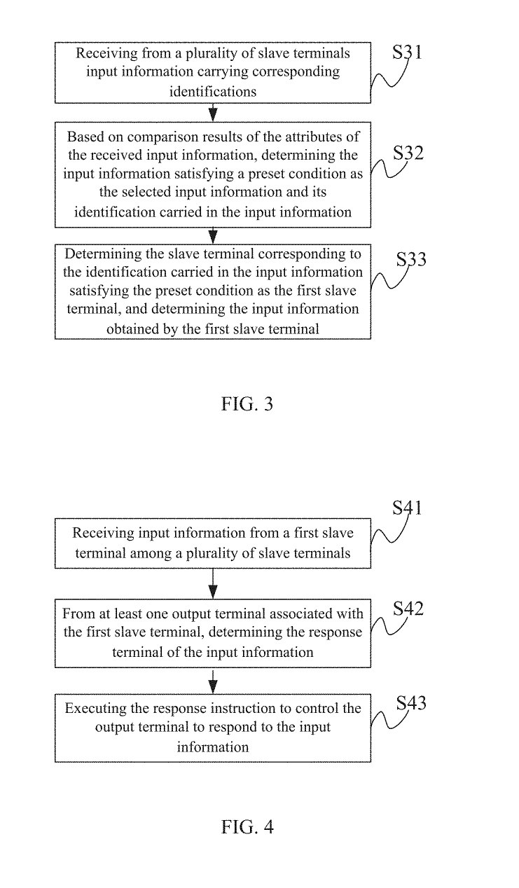

When a plurality of slave terminals transmit input information, the first slave terminal may be determined in various ways. For example, FIG. 3 illustrates a method for determining the first slave terminal and its corresponding input information. As shown in FIG. 3, the method may include the following steps.

Step S31: Receiving from a plurality of slave terminals input information carrying corresponding identifications.

The identification may be a unique identifier identifying the slave terminal, such as the IP address of the slave terminal, or any appropriate identifier of the slave terminal.

Step S32: Based on comparison results of the attributes of the received input information, determining the input information satisfying a preset condition as the selected input information and its identification carried in the input information.

Step S33: Determining the slave terminal corresponding to the identification carried in the input information satisfying the preset condition as the first slave terminal, and determining the input information obtained by the first slave terminal.

That is, after receiving the input information from the plurality of slave terminals, the master terminal can directly compare the attributes of the received input information, so as to determine the input information satisfying the preset condition as the selected input information and its carried identification. Optionally, the server may perform these actions instead of the master terminal.

Specifically, the attributes of the input information of the plurality of slave terminals may be compared among one another, or the attributes of the input information of the plurality of slave terminals may be compared with a threshold value and the attributes above the threshold may then be compared with each other.

Further, when the input information is voice information, the attribute comparison of the plurality of input information may be performed based on the signal strength, the time when the input information is received by the master terminal, and/or the sound source angle determined based on the received input information, etc.

That is, the preset condition may be whether the input information has the strongest signal strength, the fastest transmission of the input information, and/or the most desired sound source detecting angle. The preset condition may also be adjusted based on any change on the attributes of the input information to be compared.

Accordingly, because the plurality of slave terminals detect or collect the sound signal outputted from the same sound utterance object, the receiving time of the input information from the plurality of slave terminals by the master terminal can reflect the performance of the corresponding slave terminals on detecting and transmitting the input information. Thus, the slave terminal with the best performance can be selected as the first slave terminal, further improving the control efficiency.

The sound source detection angle may be the angle between the direction of the sound signal outputted by the sound utterance object and the detection direction of the slave terminal. When the direction of the sound signal outputted by the sound utterance object matches the detection direction of the slave terminal, the slave terminal may be determined as using the most desired sound source detection angle.

Accordingly, when the master terminal receives the input information from the plurality of slave terminals, the master terminal can compare the attributes of the received input information, so as to determine the input information suitable for extracting data from, i.e., the selected input information from the first slave terminal, improving the reliability of the analysis results when analyzing the input information.

Returning to FIG. 2, the control method may further include the following steps.

Step S22: Determining that the first slave terminal is a response terminal of the input information.

Because the input information detected or collected by the first slave terminal may be the only valid input information from the input information detected by the plurality of slave terminals, to improve the reliability of the input information analysis result and to improve the control accuracy, the first slave terminal may be directly selected as the response terminal to respond to the input information.

The first slave terminal may also be a fixed slave terminal among the plurality of slave terminals that has the functionality of responding to the input information, so as to ensure that the first slave terminal is capable of responding to the input information. Thus, when the specific content of the input information is different, a different first slave terminal may be used, i.e., a different fixed slave terminal among the plurality of slave terminals, and the corresponding functionality of responding to the input information may also be different.

For example, when the input information is voice information for “playing music”, the first slave terminal may have an audio playback function. When the input information is voice information for “displaying a picture”, the first slave terminal may have a picture display function. When the input information is voice information of “turning on light”, the first slave terminal may have an illumination or lighting function or the like. Other functions and first slave terminals may also be used.

Step S23: Based on the obtained input information, determining the response instruction.

Specifically, if the input information is voice information, a voice related algorithm may be used to process the input information to determine the response instruction of the input information. The present disclosure does not limit the method for determining the response instruction corresponding to the input information.

Optionally, attribute information may be extracted from the input information so as to determine the response instruction based on the attribute information. The attribute information may include corresponding feature words or keywords configured for different response instructions for the plurality of output terminals. Thus, after extracting the attribute information from the input information, the response instruction corresponding to the attribute information can be used as the response instruction of the input information. Of course, the response instruction may be directly generated based on the attribute information extracted from the input information.

Step S24: Executing the response instruction to control the first slave terminal to respond to the input information.

Specifically, the master terminal can communicate with the plurality of slave terminals to perform data exchange via wireless means, such as Bluetooth or WIFI, or via wired means. After the master terminal determines the response instruction of the input information and the response terminal, the response instruction can be executed and the first slave terminal can be controlled via the corresponding communication channel to respond to the input information.

To execute the response instruction, the master terminal may send the response instruction to the first slave terminal and control the first slave terminal to use information stored in the first slave terminal or to use its own function to respond to the input information. For example, when the input information is voice information for “playing music”, the master terminal may send the audio playback instruction to the first slave terminal so as to trigger the first slave terminal to play back the audio data stored in the first slave terminal.

Optionally, in Step S23, based on the obtained input information, the response data of the input information may also be determined. After the master terminal determines the response instruction of the input information, the master terminal can execute the response instruction to send the corresponding response data to the first slave terminal to be outputted. For example, the input information is voice information for “playing a lullaby”, and the master terminal can determine the audio playback response instruction and the audio data (i.e., audio data of the lullaby). Further, when the audio playback response instruction is executed, the audio data is sent to the first slave terminal for playback.

That is, the audio data to be played back by the first slave terminal may be stored in advance on the first slave terminal, or may be stored on the master terminal or the server. The master terminal or the server may also search matching audio data based on the analysis result of the input information. Other methods for obtaining the audio data may also be used.

It should be noted that the response data of the input information is not limited to the above-described audio data, and may vary depending on the input information, such as picture information, video data, and/or control parameters, etc. The particular implementation may be similar to the application of the above-mentioned audio data.

Accordingly, when the master terminal receives input information transmitted from the first slave terminal of a plurality of slave terminals, the first slave terminal can be directly determined as the response terminal of the input information. Further, after the response instruction is determined based on the analysis result of the input information, the response instruction can be executed to control the first slave terminal to respond to the input information, meeting the user's requirements and increasing control accuracy.

Further, by deploying a plurality of slave terminals in the application scene, the sound signal outputted from the sound utterance object can be collected in time, and the corresponding input information can be obtained in such a manner that the master terminal can promptly obtain the input information collected by the first slave terminal and control the first slave terminal to respond to the input information, further improving the efficiency and reliability to respond to the input information.

FIG. 4 illustrates another control method consistent with the disclosed embodiments. Different from those described above, according to this control method, an output terminal may be directly determined as the response terminal of the input information to respond to the input information. As shown in FIG. 4, the control method may include the following steps.

Step S41: Receiving input information from a first slave terminal among a plurality of slave terminals. Specifically, Step S41 may be similar to Step S21 described above, detail description of which is omitted herein.

Step S42: From at least one output terminal associated with the first slave terminal, determining the response terminal of the input information.

In practical applications, correspondence relationship between a plurality of slave terminals and a plurality of output terminals may be established in advance and the established correspondence relationships are stored. Thus, after the master terminal receives the input information from the first slave terminal among the plurality of slave terminals, the master terminal can use the stored correspondence relationships to determine the at least output terminal associated with the first slave terminal. Further, from the at least one output terminal, the master terminal may determine an output terminal capable of responding to the input information as the response terminal of the input information.

For example, if the current application scene is a smart home scene, the output terminal may be an intelligent home apparatus in the house, and the slave terminals may be terminals that are deployed at different locations in the house to collect and transmit the sound signal from a user. Various application scenes may be included.

Further, the type of each output terminal associated with the slave terminal may be different, and different types of out terminals may support different response modes. When an output terminal associated with the first slave terminal is determined to respond to the input information, the output terminal may be uniquely selected from the at least one output terminal associated with the first slave terminal as the response terminal to respond to the input information. That is, the output terminal having the configuration information (e.g., type) to respond to the input information is determined as the response terminal of the input information.

Thus, based on the response mode and the configuration information of all output terminals associated with the first slave terminal, one output terminal may be determined as the response terminal of the input information. For example, one output terminal with matching response mode and/or type with respect to the input information.

Step S43: Executing the response instruction to control the output terminal to respond to the input information.

Similarly, in Step S43, the response data of the input information may be determined based on the analysis result of the input information. Further, the response data may be transmitted to the output terminal for outputting, or the output terminal may be directly controlled to use its own stored data to respond to the input information.

Accordingly, when the master terminal receives input information transmitted from the first slave terminal among a plurality of slave terminals, the response terminal of the input information can be accurately and quickly determined directly from at least one output terminal associated with the first slave terminal, so as to respond to the input information and to increase control efficiency and accuracy.

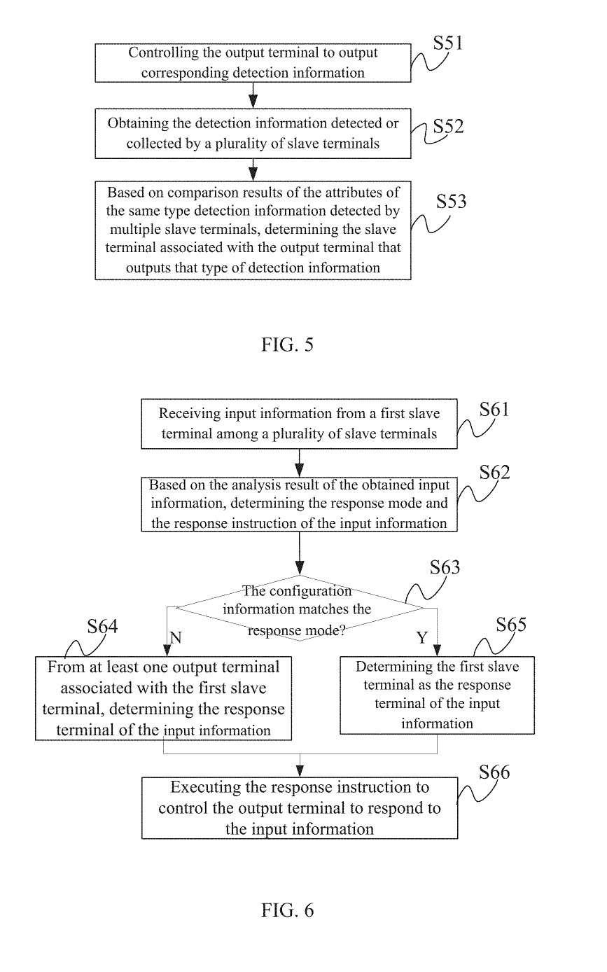

Further, the association relationship between a slave terminal and an output terminal may be determined in various ways. For example, FIG. 5 illustrate a method for determining the association relationship between a slave terminal and an output terminal. As shown in FIG. 5, the method may include the following steps.

Step S51: Controlling the output terminal to output corresponding detection information.

An application scene may include a plurality of output terminals. One output terminal may be controlled at one time to output its corresponding detection information, and the detection information may be used to determine which slave terminal is associated with the one output terminal. A second output terminal may then be controlled to output its corresponding detection information to determine the slave terminal associated with the second output terminal. Such operation is repeated until all output terminals in the current application scene output the corresponding detection information.

Further, the type of detection information output from each output terminal in the current application scene may be different, and the type of the detection information may be determined based on its contents. Under such circumstance, to improve efficiency, all output terminals may be controlled to output their corresponding detection information so that all the detection information that can be collected at the same time by the master terminal, without the need to repeat the determination and collection operations. Thus, the time for outputting the output terminal detection information and collecting the detection information by the master terminal can be shortened, and the efficiency of determining the relationship between the terminal and the output terminal can be improved.

Thus, Step S51 may include the master terminal controlling each output terminal to output the corresponding detection information each time and, after determining the slave terminal associated with the output terminal, controlling another output terminal to output the corresponding detection information, which is repeated until all output terminals output detection information. Optionally, the master terminal may control one output terminal to output corresponding detection information at a preset time period, which may be determined based on the time taken to determine the slave terminal associated with an output terminal.

In addition, Step S51 may also include the master terminal controlling a plurality of output terminals to output corresponding detection information at the same time. Other methods for controlling the output terminals to output the corresponding detection information may also be used.

Step S52: Obtaining the detection information detected or collected by a plurality of slave terminals.

When the master terminal, in Step S51, controls one output terminal at a time to output the detection information, all slave terminals that can detect the detection information may transmit the detected detection information to the master terminal. The master terminal may receive same type of detection information from multiple slave terminals.

When the master terminal, in Step S51, controls all output terminals to output the detection information at once, one slave terminal can detect a plurality of types of detection information. The detection information obtained by the master terminal may include a plurality of types of detection information detected by multiple slave terminals.

Step S53: Based on comparison results of the attributes of the same type detection information detected by multiple slave terminals, determining the slave terminal associated with the output terminal that outputs that type of detection information.

That is, in the various control methods, the same type of detection information and its corresponding slave terminals can be determined first. Further, the master terminal or the server compares the attributes of the same type detection information to select the detection information with the best or most desired attribute, and to associate the output terminal outputting the detection information of that type with the slave terminal detecting the detection information of the best attribute. After analyzing the various types of detection information, the association relationship between multiple output terminals and multiple slave terminals in the current application scene can then be determined and, further, be sent to the corresponding slave terminal, the master terminal, or the server for storage.

Because the attributes of the different types of detection information contain different contents, the attribute comparison process for different types of detection information may be different. For example, when the detection information includes audio type information, i.e., the output terminal outputs a sound signal, the attribute to be compared may include signal strength, signal transmission time, and/or audio source angle relative to each corresponding slave terminal, etc. The specific comparison process may refer to previously described voice information attribute analysis process.

When the detection information includes light type information, the slave terminals may include light detectors, and the attribute to be matched or compared may include light intensity, light propagation direction, or light detection direction, etc., of the collected detection information. As such, Step S53 may include comparing the light intensity and/or the light propagation direction of the detection information to select the detection information with the highest light intensity or with the light propagation direction matching the detection direction of the corresponding slave terminal as the most desired detection information of that type of detection information. Further, the output terminal for outputting that type of detection information is associated with the slave terminal detecting the most desired detection information.

It should be noted that the types of the detection information outputted by the output terminals are not limited to the two types listed above. Other types of detection information may also be included and, for the analysis process of the other types of detection information, most desired detection information of various detection information of a same type can be determined first, and the output terminal for outputting that type of detection information is then associated with the slave terminal detecting the most desired detection information.

Further, after determining at least one output terminal associated with each of the slave terminals, based on location information of the associated output terminals, a spatial region associated with the slave terminal may also be determined. That is, according to the present disclosure, the current application scene may be divided into spatial regions. The corresponding relationship between the divided spatial regions and the plurality of slave terminals and the master terminal may be determined and stored. Thus, in the practical applications, after determining the first slave terminal, the spatial region corresponding to the first slave terminal is obtained and, from the output terminals located in the spatial region, a response terminal of the input information may be determined.

Optionally, when no output terminal capable of responding to the input information can be found in the spatial region corresponding to the first slave terminal, spatial regions adjacent to the spatial region may be further searched to find output terminals capable of responding to the input information as the response terminal of the input information. The corresponding relationship between the divided spatial regions and the plurality of slave terminals and the master terminal may be determined by multiple tests or any other appropriate methods.

Using a smart home application scene as an example, the spatial region may be a room of the application scene. When the user issues a voice command in a certain room, a slave terminal in this room (at this time, the slave terminal is also the first slave terminal) detects the input information and transmits the input information to the master terminal or the server for subsequent processing. The slave terminal or other intelligent home apparatus located in the room may be determined as the response terminal to respond to the input information to achieve the user's voice command. However, if there is no intelligent home apparatus found in the room that is capable of responding to the input information, a next room may be searched, and so on, to achieve the user's demand.

Accordingly, when there needs an output terminal to respond to the input information, the association relationship between the output terminals and the slave terminals can be established in advance and, based on the association relationship, the response terminal of the input information can be timely determined, thereby improving control efficiency.

FIG. 6 illustrates another control method consistent with the disclosed embodiments. Different from previously described methods, according to this control method, it is first determined whether the first slave terminal can respond to the input information and, if cannot, at least one output terminal associated with the first slave terminal can be used to determine a response terminal of the input information to respond to the input information. Specifically, as shown in FIG. 6, the control method may include the following steps.

Step S61: Receiving input information from a first slave terminal among a plurality of slave terminals. Specifically, Step S61 may be similar to Step S21 described above, detail description of which is omitted here.

Step S62: Based on the obtained input information, determining the response mode and the response instruction of the input information.

For example, the response mode of the input information may be determined based on the specific contents included in the input information. If the input information is voice information “playing music”, the response mode may be an audio mode; when the input information is voice information “turning on light”, the response mode of the input information may be an illumination mode. Thus, the response mode of the input information is consistent with the intent of the user, and the response mode of the input information may be used as a basis to determine the response terminal.

Step S63: Verifying whether the configuration information of the first slave terminal matches the response mode. If not matching, the method is proceeded to Step S64; and if matching, Step S65 is performed.

Optionally, the configuration information of each slave terminal may be stored in advance, such that the function of each slave terminal can be determined. Further, the configuration information of each output terminal may also be stored to facilitate determination of the output terminal of the input information.

For example, when the response mode is the audio mode, the configuration information of the first slave terminal may be verified to determine whether the first slave terminal has the audio player capability, i.e., the audio-player configuration information. When the response mode is the picture display mode, it can be verified whether the first slave terminal has the picture-output-device configuration information. When the response mode is a lighting or illumination mode, it can be verified whether the first slave terminal has the lighting-device configuration information. Thus, it can be verified whether the first slave terminal can respond to the input information. Other response modes may also be used.

Step S64: From at least one output terminal associated with the first slave terminal, determining the response terminal of the input information, similar to relevant description of FIG. 4.

Step S65: Determining the first slave terminal as the response terminal of the input information.

Step S66: Executing the response instruction to control the output terminal to respond to the input information.

Accordingly, by verifying the first slave terminal, it can be avoided to determine the first slave terminal whose configuration information does not match the response mode of the input information as the response terminal, as the first slave terminal cannot respond to the input information, and the response terminal needs to be re-determined, thereby improving the control accuracy of responding to the input information.

Further, the input information may be detected or collected by the master terminal itself. That is, Step S11 may include obtaining the input information detected or collected by the master terminal. In such case, the master terminal may be directly determined as the response terminal of the input information; the response terminal of the input information may be determined from at least one output terminal associated with the master terminal, or it may be verified whether the configuration information of the master terminal matches the response mode of the input information and, if matching, the master terminal is determined as the response terminal of the input information, and if not matching, the response terminal of the input information is determined from the at least one output terminal associated with the master terminal.

The process of determining the association relationship between the master terminal and the output terminal, and the process of determining the response terminal of the input information is determined from the at least one output terminal associated with the master terminal may refer to similar portions described previously.

Thus, in practical applications, various methods may be used to quickly and accurately determine the response terminal of the input information, and the master terminal can execute the response instruction to control the response terminal to respond to the input information in a timely manner, meeting the user's demand and improving the control efficiency and accuracy.

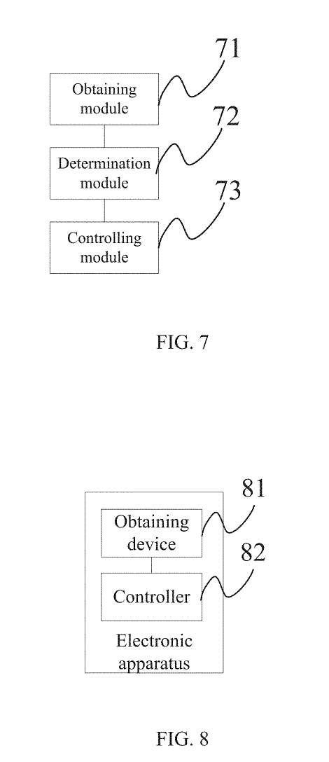

FIG. 7 illustrates a structural diagram of a controller consistent with the disclosed embodiments. The controller may be applied to the master terminal. As shown in FIG. 7, the controller may include an obtaining module 71, a determination module 72, and a control module 73. Other components may also be included.

The obtaining module 71 may obtain input information. According to the disclosed control methods, the input information may be collected by a slave terminal and transmitted to the master terminal, or may be obtained by the master terminal itself. Thus, the obtaining module 71 may further include a receiving unit and a collecting unit. The receiving unit receives the input information from a first slave terminal among a plurality of slave terminals. The collection unit collects the input information.

The determination module 72 determines a response instruction and a response terminal of the input information based on the analysis result of the input information. In practical applications, the analysis of the input information may be performed by the master terminal or by the server.

When the obtaining module 71 includes the receiving unit, the determining module 72 may include a first determining unit for determining the first slave terminal as a response terminal of the input information; or a second determining unit for determining a response terminal of the input information from at least one output terminal associated with the first slave terminal.

The specific process for determining the response terminal of the input information with respect to the first determining unit and the second determining unit may refer to the descriptions of the corresponding control methods.

In certain embodiments, the obtaining module 71 may include a first obtaining unit for obtaining a response mode of the input information based on the analysis result of the obtained input information; and a second obtaining unit for obtaining a response instruction of the input information based on the analysis result of the obtained input information.

In practical applications, the response mode may be used as a basis for determining the response terminal of the input information, and the obtaining module 71 may further include a verifying unit for verifying whether the configuration information of the first slave terminal matches the response mode; a third determining unit for, when the verification result of the verification unit is yes, determining the first slave terminal as the response terminal of the input information; and a fourth determining unit for, when the verification result of the verification unit is no, determining the response terminal of the input information from at least one output terminal associated with the first slave terminal.

It should be noted that the specific process by the third determining unit and the fourth determining unit may also refer to the descriptions of the corresponding control methods.

Further, the control module 73 executes the response instruction to control the response terminal to respond to the input information.

When the determined response terminal is different, the control process by the control module 73 may also be adjusted, and the specific process may refer to the descriptions of the corresponding control methods.

Optionally, the determination module 72 may further include a fifth determining unit for determining the response data of the input information based on the analysis result of the obtained input information, and the control module 73 may, executing the response instruction, send the response data to the response terminal for outputting.

Accordingly, after the master terminal obtains the input information, the master terminal may, based on the analysis result of the input information, accurately and quickly determine the corresponding response instruction and the response terminal. By executing the response instruction, the response terminal can be controlled to respond to the input information. Thus, based on the sound signal inputted by the user, the present disclosure can accurately determine the user's intention and meet the user's current needs, improving the control efficiency and accuracy.

Optionally, when the master terminal receives input information collected by a plurality of slave terminals, to determine the input information collected by the first slave terminal, the receiving unit may specifically include a receiving sub-unit for receiving from a plurality of slave terminals input information carrying corresponding identifications; a first determining sub-unit for, based on comparison results of the attributes of the received input information, determining the input information satisfying a preset condition as the selected input information and its identification carried in the input information; and a second determining sub-unit for determining the slave terminal corresponding to the identification carried in the input information satisfying the preset condition as the first slave terminal, and determining the input information obtained by the first slave terminal.

The input information satisfying the preset condition may be the input information with the best attribute, and the specific determination process may refer to the descriptions of the corresponding control methods.

In addition, to determine the association relationship between the slave terminals and the output terminals, the controller may further include a second control module, an information obtaining module, and an association relationship determining module.

The second control module may control the output terminal to output corresponding detection information.

Specifically, the second control module may control each output terminal to output the corresponding detection information one at a time and, after determining the slave terminal associated with the output terminal, control another output terminal to output the corresponding detection information. Such operation may be repeated until all output terminals output the detection information. Or the second control module may control all output terminals to output corresponding detection information at the same time to realize the detection of the association relationship between the slave terminals and the output terminals, etc.

The information obtaining module obtains detection information collected by a plurality of slave terminals.

The association relationship determining module determines, based on comparison results of the attributes of the same type detection information detected by multiple slave terminals, the slave terminal associated with the output terminal that outputs that type of detection information. The specific process for determining the association relationship may refer to the descriptions of the corresponding control methods.

When the current application scene is divided into spatial regions, each spatial region corresponds to a slave terminal and, to determine the response terminal of the input information from at least one output terminal associated with the first slave terminal, the second determining unit or the fourth determining unit may include an obtaining sub-unit and a third determining sub-unit.

The obtaining sub-unit stores a spatial region corresponding to the first slave terminal. The third determining sub-unit determines a response terminal of the input information from the at least one output terminal located in the spatial region.

It should be noted that the dividing process of the spatial regions may refer to the descriptions of the corresponding control methods.

Thus, in practical applications, whether determining the master terminal, the first slave terminal, or the output terminal as the response terminal of the input information, it can accurately and promptly determine the response terminal based on the analysis result of the input information, and the response terminal can respond to the input information, thereby meeting the user needs and greatly improving the control efficiency and accuracy.

FIG. 8 illustrates an electronic apparatus consistent with the disclosed embodiments. The electronic apparatus may be a master terminal and may include any appropriate electronic components to achieve various functions of the electronic apparatus. Specifically, as shown in FIG. 8, the electronic apparatus may include an obtaining device 81 and a controller 82. Other devices may also be included.

The obtaining device 81 obtains input information, i.e., an electronic input device that can be coupled to the controller 82 to receive the input information. In practical applications, the specific results of the obtaining device 81 may be different depending on the different object directly collecting the input information. When the input information is directly collected by the electronic apparatus itself, the obtaining device 81 may be a collecting device used to collect the input information.

Based on the different types of the input information, the collecting device may be a sound collector or microphone, a light sensor, an image capturer, or other sensors and input devices, etc.

In addition, when the input information is sent to the electronic apparatus after being collected by a slave terminal, the obtaining device 81 may be a communication device, i.e., an electronic input device having a communication function, such as a transceiver, a wireless modem, or other communication module, for receiving the input information collected by the first slave terminal among a plurality of slave terminals.

The controller 82 may include any appropriate processors and other electronic components to provide control functionalities of the electronic apparatus. For example, the controller 82 may include any appropriate type of graphic processing unit (GPU), general purpose microprocessor, digital signal processor (DSP) or microcontroller, and application specific integrated circuit (ASIC). The controller 82 may also include a random access memory (RAM), a read-only memory (ROM), a communication interface, an input/output interface, a display, and/or a storage. Other components may be added and certain devices may be removed without departing from the principles of the disclosed embodiments.

Regarding the sound signal generated in the current application scene, if only one slave terminal detects the sound signal, the only slave terminal is the first slave terminal. If multiple slave terminals detect the sound signal, one slave terminal most desired to send the input information to the electronic apparatus may be determined from the multiple slave terminal as the first slave terminal; or all the slave terminals in the current application scene may collect the input information and send the obtained input information to the master terminal so as to determine the input information with the best attribute as the selected input information, and to determine the slave terminal sending the input information with the best attribute as the first slave terminal. The input information from the first slave terminal may then be used for further processing.

The controller 82 may determine, based on the obtained input information (e.g., the analysis result of the obtained input information), a control instruction and a response terminal of the input information and may execute the response instruction to control the response terminal to respond to the input information.

As described above, when the obtaining device 81 is a collecting device, the controller 82 may specifically determine the electronic apparatus as the response terminal of input information; or may determine the response terminal of the input information from at least one output terminal associated with the electronic apparatus; or may first verify whether the configuration information of the electronic apparatus matches the response mode of the input information, determine the electronic apparatus as the response mode of the input information if matching, and determine the response terminal of the input information from at least one output terminal associated with the electronic apparatus if not matching.

Similarly, when the obtaining device 81 is specifically the communication device, the controller 82 may specifically determine that the first slave terminal as the response terminal of the input information; or determine the response terminal of the input information from at least one output terminal associated with the first slave terminal; or first verify whether the configuration information of the first slave terminal matches the response mode of the input information, determine the first slave terminal as the response mode of the input information if matching, and determine the response terminal of the input information from at least one output terminal associated with the first slave terminal if not matching.

Optionally, to determine a first slave terminal from a plurality of slave terminals, the attributes of the input information transmitted by the plurality of slave terminals can be compared and analyzed. Specifically, the communication device may receive the input information from the plurality of slave terminals carrying the corresponding identifications.

Correspondingly, the controller 82 may determine, based on the comparison results of the attributes of the received input information from the plurality of slave terminals, the input information satisfying the preset condition and the identification thereof. Further, the controller 82 may determine the slave terminal corresponding to the identification carried in the input information satisfying the preset condition as the first slave terminal and determine the input information collected by the first slave terminal. The various methods for determining the first slave terminal may refer to the descriptions of the corresponding control methods.

Further, to determine the association relationship between the plurality of slave terminals and the plurality of output terminals, the controller 82 may control the output terminals to output corresponding detection information. After the communication device received the detection information from the plurality of slave terminals, based on the comparison results of the attribute of the same type detection information from the plurality of slave terminals, the controller 82 may determine the slave terminal associated with the output terminal that outputs that type of detection information. Thus, the slave terminal associated with each output terminal in the current application scene can be automatically detected.

Optionally, after receiving the input information from the first slave terminal among the plurality of slave terminals, the controller 82 may obtain a pre-stored spatial region corresponding to the first slave terminal and determine the response terminal of the input Information from the spatial region.

Thus, whether to determine the electronic apparatus, the first slave terminal, or the output terminal as the response terminal of the input information, the electronic apparatus can accurately and promptly determine the response terminal based on the analysis result of the input information, and the response terminal can respond to the input information, thereby meeting the user needs and greatly improving the control efficiency and accuracy.

Accordingly, after the electronic apparatus obtains the input information, based on the analysis result of the obtained input information, the electronic apparatus can quickly and accurately determine the corresponding response instruction and the response terminal of the input information, and the electronic apparatus can execute the response instruction to control the response terminal to respond to the input information in a timely manner. Thus, based on the sound signal inputted by the user, the present disclosure can accurately determine the user's intention and meet the user's current needs, improving the control accuracy.

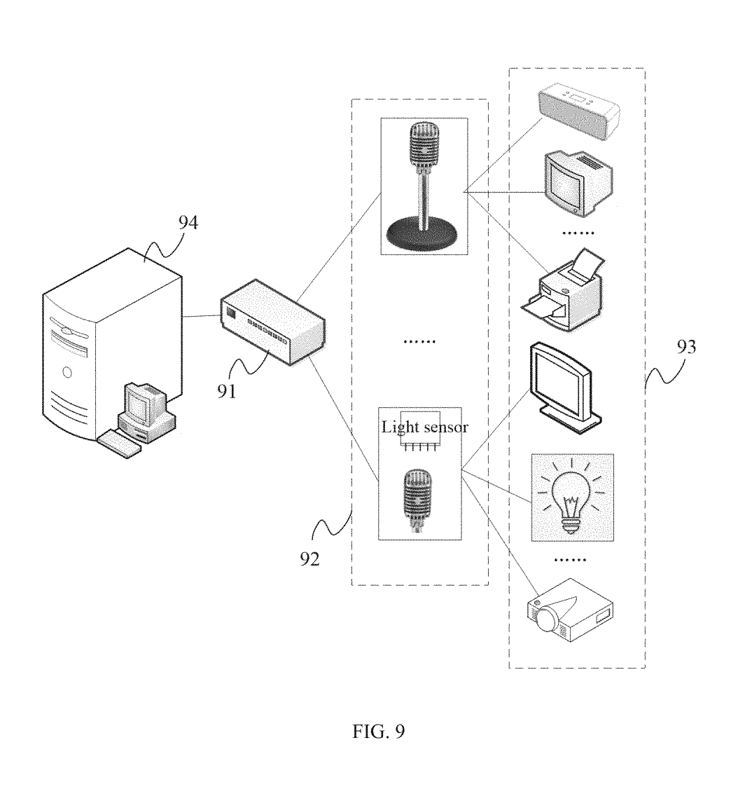

FIG. 9 illustrates a control system consistent with the disclosed embodiments. As shown in FIG. 9, the control system may include an electronic apparatus 91, a plurality of slave terminals 92 and a plurality of output terminals 93, and may also include a server 94. Other components may also be included.

The slave terminals may include, for example, one slave terminal as a sound collector (such as the microphone in FIG. 9) and another slave terminal as a sound collector and a light sensor. The output terminals may include, for example, a speaker, a monitor, a printer, a display, a lamp, and a projector, etc. Different slave terminals and/or output terminals may be used depending on different application scenes.

In practical applications, the plurality of slave terminals 92 can perform data exchange with the electronic apparatus 91 and the associated output terminals 93 by wireless or wired means. Similarly, the electronic apparatus 91 may also communicate with the server 94 either wirelessly or in a wired manner. Thus, the electronic apparatus may realize the above-mentioned control methods and, based on the sound signal inputted by the user, can accurately determine the response terminal, and to control the response terminal to respond to the input information, meeting the user's needs and improving the control efficiency and accuracy.

Further, in the present disclosure, relational terms such as first, second, and the like, may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Further, various functional units discussed in the disclosed embodiments may be implemented as software functional units. The software may be stored on computer readable storage media. Based on this understanding, all or a part of the generic principles or the scope of the invention may be embodied in software products. The computer software products may be stored in storage media and may include a plurality of commands to instruct a computer system (such as personal computer, server, network system, etc.) or a processor to execute all or a part of the procedures described in various embodiments consistent with the present disclosure. The storage media may include U disk, mobile hard disk, read-only memory (ROM), random access memory (RAM), magnetic disk, optical disk, or any other appropriate media that can be used to store program code.

Various embodiments of the present specification are described in a progressive manner, in which each embodiment focusing on aspects different from other embodiments, and the same and similar parts of each embodiment may be referred to each other. Because the disclosed devices correspond to the disclosed methods, the description of the disclosed devices and the description of the disclosed methods may be read in combination or in separation.

The description of the disclosed embodiments is provided to illustrate the present invention to those skilled in the art. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method, comprising:
obtaining, by a master terminal, input information;
based on the input information, determining a response instruction and a response terminal of the input information; and
executing the response instruction to control the response terminal to respond to the input information.

2. The method according to claim 1, wherein:
the obtaining input information further includes:
obtaining input information collected by a first slave terminal among a plurality of slave terminals; and
the determining a response instruction and a response terminal of the input information further includes:
determining the first slave terminal as the response terminal of the input information.

3. The method according to claim 1, wherein:
the obtaining input information further includes:
obtaining input information collected by a first slave terminal among a plurality of slave terminals; and
the determining a response instruction and a response terminal of the input information further includes:
determining the response terminal of the input information from at least one output terminal associated with the first slave terminal.

4. The method according to claim 1, wherein the determining a response instruction and a response terminal of the input information further includes:
based on the input information, determining a response mode of the input information; and
determining a slave terminal with configuration information matching the response mode as the response terminal of the input information.

5. The method according to claim 4, wherein:
the obtaining input information further includes:
obtaining the input information collected by a first slave terminal among a plurality of slave terminals; and
the determining a slave terminal with configuration information matching the response mode as the response terminal of the input information further includes:
verifying whether configuration information of the first slave terminal matches the response mode;
in response to the configuration information of the first slave terminal matching the response mode, determining the first slave terminal as the response terminal of the input information; and
in response to the configuration information of the first slave terminal not matching the response mode, determining the response terminal of the input information from at least one output terminal associated with the first slave terminal.

6. The method according to claim 2, wherein the obtaining the input information collected by a first slave terminal among a plurality of slave terminals further includes:
receiving input information from the plurality of slave terminals carrying corresponding identifications;
based on a comparison result of attributes of the input information from the plurality of slave terminals, determining input information satisfying a preset condition and a corresponding identification; and
determining a slave terminal with configuration information matching the response mode as the response terminal of the input information.

7. The method according to claim 3, further including:
controlling the plurality of output terminals to output detection information;
obtaining detection information collected by the plurality of slave terminals; and
based on a comparison result of attributes of a same type detection information collected by the plurality of slave terminals, determining a slave terminal associated with an output terminal outputting this type detection information.

8. The method according to claim 3, wherein the determining the response terminal of the input information from at least one output terminal associate with the first slave terminal further includes:
obtaining a pre-stored spatial region corresponding to the first slave terminal; and
determining the response terminal of the input information from the spatial region.

9. The method according to claim 3, wherein the determining the response terminal of the input information from the spatial region further includes:
determining the response terminal of the input information as an output terminal associated with the first slave terminal in the spatial region.

10. An electronic apparatus, comprising:
an electronic input device; and
a controller coupled to the electronic input device,
wherein the electronic input device obtains input information; and
the controller determines, based on the input information, a response instruction and a response terminal of the input information, and executes the response instruction to control the response terminal to respond to the input information.

11. The electronic apparatus according to claim 10, the electronic input device is a device selected from the group consisting of:
an electronic sensor directly collecting the input information; and
an electronic input device having a communication function to receive the input information collected by a first slave terminal among a plurality of slave terminals.

12. The electronic apparatus according to claim 11, wherein the electronic input device includes the electronic input device having a communication function, and the electronic apparatus further includes:
a memory for storing configuration information of the slave terminals,
wherein the controller determines a slave terminal with configuration information matching a response mode of the input information as the response terminal of the input information.

13. The electronic apparatus according to claim 12, wherein:
the controller verifies whether configuration information of the first slave terminal matches the response mode, in response to the configuration information of the first slave terminal matching the response mode, determines the first slave terminal as the response terminal of the input information and, in response to the configuration information of the first slave terminal not matching the response mode, determines the response terminal of the input information from at least one output terminal associated with the first slave terminal.

14. The electronic apparatus according to claim 11, wherein the electronic input device includes the electronic input device having a communication function, and the electronic apparatus further includes:
a memory for storing association relationship between the plurality of slave terminals and a plurality of output terminals,
wherein the controller determines the response terminal from at least one output terminal associated with the first slave terminal based on the association relationship.

15. The electronic apparatus according to claim 11, wherein:
the controller obtains input information collected by a first slave terminal among a plurality of slave terminals, and determines the first slave terminal as the response terminal of the input information.

16. The electronic apparatus according to claim 11, wherein:
the controller obtains input information collected by a first slave terminal among a plurality of slave terminals, and determines the response terminal of the input information from at least one output terminal associate with the first slave terminal.
